(19) United States
(12) Patent Application Publication
(10) Pub. No.: US 2026/0112182 A1
(43) Pub. Date: Apr. 23, 2026

(54) System and Method for a Smart Logo Platform

(71) Applicant: TapText llc, Coral Springs, FL (US)

(72) Inventors: Steve Doumar, Fort Lauderdale, FL (US); Brian Galvin, Silverdale, WA (US); David Teodosio, Guilford, CT (US)

(21) Appl. No.: 19/250,747

(22) Filed: Jun. 26, 2025

Related U.S. Application Data
(60) Provisional application No. 63/665,216, filed on Jun. 27, 2024.

(51) Int. Cl. G06V 20/62; H04L 51/04

(52) U.S. Cl. CPC G06V 20/63; H04L 51/04; G06V 2201/09

(57) ABSTRACT

The present invention provides a system and method for interactive logo recognition and user engagement using mobile devices. The system may detect logos in real-time using a mobile device's camera and a deep learning-based object detection model. Upon logo detection, a deeplink may be retrieved, activating a messaging application and prepopulating a ready-to-send message to a server. The server may generate a personalized response using natural language processing, including selectable action elements. Users can interact with elements, triggering associated actions and engaging with the brand. The invention combines computer vision, augmented reality, and mobile technologies to create intuitive user experience.

### CROSS-REFERENCE TO RELATED APPLICATIONS

Priority is claimed in the application data sheet to the following patents or patent applications, each of which is expressly incorporated herein by reference in its entirety: 63/665,216

### BACKGROUND OF THE INVENTION

### Field of the Art

The present invention relates to the field of computer vision, artificial intelligence, and mobile computing. More specifically, it pertains to systems and methods for interactive logo recognition and user engagement using mobile devices, deep learning techniques, and augmented reality technologies.

### Discussion of the State of the Art

In recent years, there has been a growing interest in developing innovative ways for brands to connect with consumers and create engaging experiences. With the widespread adoption of smartphones and advances in computer vision and artificial intelligence, new opportunities have emerged for interactive marketing and user engagement.

Traditionally, QR codes have been used as a means to bridge the gap between physical and digital content. Users can scan QR codes using their mobile devices to access websites, product information, or promotional offers. However, QR codes often lack visual appeal and require explicit user action to scan and interact with them.

On the other hand, logo recognition technology has been used in various applications, such as brand monitoring, copyright infringement detection, and augmented reality experiences. Existing methods for logo recognition typically involve training deep learning models, such as Convolutional Neural Networks (CNNs), on large datasets of logo images. These models learn to extract relevant features and patterns from the images to identify and classify logos accurately.

However, current logo recognition systems often focus on offline processing of images or videos, lacking real-time interaction capabilities. They may also require users to capture images explicitly and upload them for analysis, which can be cumbersome and hinder user engagement. Moreover, while some augmented reality applications have explored the concept of overlaying digital content based on recognized logos, they often rely on predefined markers or specific logo designs, limiting their scalability and adaptability to diverse logo variations.

In light of these limitations, there is a need for a more intuitive, engaging, and real-time solution that combines logo recognition, user interaction, and augmented reality to create interactive experiences for users. The present invention addresses this need by providing a novel system and method for detecting logos in real-time using a mobile device's camera, triggering personalized actions, and enabling seamless user interaction through messaging platforms and natural language processing techniques.

### SUMMARY OF THE INVENTION

Accordingly, the inventor has conceived and reduced to practice a system and method for a smart logo platform. By leveraging the power of deep learning, computer vision, and mobile technologies, the present invention aims to revolutionize the way brands connect with consumers, offering a unique and immersive experience that goes beyond traditional QR code scanning or passive logo recognition. The invention opens up new possibilities for interactive marketing, customer engagement, and creative applications in various domains, such as retail, advertising, entertainment, and customer support.

The system employs a sophisticated deep learning logo identification module that processes input from various sources, including static images, videos, or live camera feeds. The input undergoes preprocessing to optimize it for analysis, after which the deep learning core, trained using advanced machine learning techniques and a specialized loss function, identifies potential logos within the visual data. The results are then refined through post-processing before being sent to a server for further analysis. The server component of the system contains a comprehensive logo database, which it uses to match the identified logos against known entries. Once a match is found, the system retrieves associated content and generates an initiator, such as a deeplink or URL, which is presented to the user on their device. When the user interacts with this initiator, the system generates and displays content directly related to the recognized logo. This content can take various forms, including pre-populated messages, phone numbers ready to dial, webpages, digital coupons, or other interactive experiences. By seamlessly connecting logo recognition with personalized digital experiences, this system creates a powerful bridge between physical branding and digital engagement, offering new opportunities for brands to connect with consumers and for users to access relevant information and interactions based on the logos they encounter in their environment.

According to a preferred embodiment, a smart logo platform, comprising one or more computers with executable instructions that, when executed, cause the platform to: receive an image, video, or live feed from a camera of a mobile device; process the image, video, or live feed through a trained logo identification model to determine whether an identified logo is in the image, video, or live feed; identify a plurality of IDs associated with the identified logos in the image, video or live feed; cross-reference any identified IDs with a database, wherein the database comprises a plurality of IDs, a plurality of selectable initiators, and a plurality of content wherein each selectable initiator and content is associated with a specific ID; display the selectable initiator associated with any identified IDs to the mobile device; and display the content associated with any identified IDs to the mobile device when the selectable initiator is interacted with, is disclosed.

According to another preferred embodiment, a method for a smart logo platform, comprising the steps of: receiving an image, video, or live feed from a camera of a mobile device; processing the image, video, or live feed through a trained logo identification model to determine whether an identified logo is in the image, video, or live feed; identifying a plurality of IDs associated with the identified logos in the image, video or live feed; cross-reference any identified IDs with a database, wherein the database comprises a plurality of IDs, a plurality of selectable initiators, and a plurality of content wherein each selectable initiator and content is associated with a specific ID; displaying the selectable initiator associated with any identified IDs to the mobile device; and displaying the content associated with any identified IDs to the mobile device when the selectable initiator is interacted with, is disclosed.

According to another preferred embodiment, a non-transitory, computer-readable storage media having computer-executable instructions embodied thereon that, when executed by one or more processors of a computing system employing an asset registry platform for a smart logo platform, cause the computing system to: receive an image, video, or live feed from a camera of a mobile device; process the image, video, or live feed through a trained logo identification model to determine whether an identified logo is in the image, video, or live feed; identify a plurality of IDs associated with the identified logos in the image, video or live feed; cross-reference any identified IDs with a database, wherein the database comprises a plurality of IDs, a plurality of selectable initiators, and a plurality of content wherein each selectable initiator and content is associated with a specific ID; display the selectable initiator associated with any identified IDs to the mobile device; and display the content associated with any identified IDs to the mobile device when the selectable initiator is interacted with, is disclosed.

According to an aspect of an embodiment, the selectable initiator associated with the identified ID is a deeplink that opens a messaging app on the mobile device when selected by a user.

According to an aspect of an embodiment, the messaging app is prepopulated with a message that includes the content associated with the identified logo.

According to an aspect of an embodiment, the plurality of selectable initiators and the plurality of content is tailored to a plurality of metadata associated with the mobile device.

According to an aspect of an embodiment, the plurality of metadata includes current location of the mobile device, the date and time that an image, video, or live feed was received from the mobile device, and the frequency of a selectable initiator associated with a specific logo being interacted with on the mobile device.

### BRIEF DESCRIPTION OF THE DRAWING FIGURES

FIG. 1A is a block diagram illustrating an exemplary system architecture of a system for a smart logo platform.

FIG. 1B is a block diagram illustrating an exemplary advanced system architecture of a system for a smart logo platform.

FIG. 2 is a block model illustrating an aspect of a system for a smart logo platform, a deep learning logo identification core.

FIG. 3 is a block model illustrating an aspect of a system for a smart logo platform, a deep learning training system.

FIG. 4 is a block diagram illustrating an exemplary system architecture of a system for a smart logo platform, where the server processes user device metadata.

FIG. 5 is a block diagram illustrating an exemplary aspect of a system for a smart logo platform, a generated initiator.

FIG. 6 is a flow diagram illustrating an exemplary method for a smart logo platform.

FIG. 7 is a flow diagram illustrating an exemplary method for displaying generated content to a user's device using a smart logo platform.

FIG. 8 is a block diagram illustrating exemplary generated content where the generated content is a deeplink to a messaging app.

FIG. 9 is a block diagram illustrating an exemplary system for tailoring generated content to a user's associated metadata using a smart logo platform.

FIG. 10 is a flow diagram illustrating an exemplary method for generating a deeplink to a messaging app using a smart logo platform.

FIG. 11 is a flow diagram illustrating an exemplary method for tailoring generated content to a user's associated metadata using a smart logo platform.

FIG. 12 illustrates an exemplary computing environment on which an embodiment described herein may be implemented.

### DETAILED DESCRIPTION OF THE INVENTION

The inventor has conceived, and reduced to practice, a system and method for a smart logo platform. The present invention integrates several cutting-edge systems to create a comprehensive solution for interactive logo recognition and user engagement. At the forefront is the deep learning logo identification core, which leverages advanced neural network architectures to accurately detect and classify logos in real-time from various input sources. This core is continuously improved through a sophisticated machine learning training system, employing techniques such as transfer learning, data augmentation, and adaptive loss functions to enhance its performance and adaptability. The inclusion of a preprocessor and post-processor ensures that the system can handle diverse input conditions and refine the neural network's output for optimal accuracy, addressing challenges that have historically limited the effectiveness of logo recognition systems in real-world scenarios.

The invention's server-side components, including the comprehensive logo database and content retrieval system, represent a significant leap forward in connecting visual recognition with personalized user experiences. By maintaining an extensive and up-to-date database of logos and associated content, the system can provide relevant and timely interactions based on recognized logos. The generated initiator and displayed content mechanisms offer an efficient approach to user engagement, seamlessly bridging the gap between physical logos and digital experiences. This integration of visual recognition, cloud-based content delivery, and mobile interaction design creates a unified system that surpasses traditional approaches to logo recognition and marketing engagement. By enabling real-time, context-aware, and personalized interactions triggered by logo recognition, the invention opens up new possibilities for brand-consumer relationships, interactive marketing, and augmented reality experiences, pushing the boundaries of what's possible in the realms of computer vision, mobile computing, and user engagement.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “deep learning core” refers to a sophisticated neural network architecture designed to extract, analyze, and classify visual features from input data. This core component serves as the primary engine for identifying and recognizing logos within images or video frames. It typically consists of multiple interconnected layers that progressively transform raw pixel data into high-level representations, ultimately enabling accurate logo classification. The deep learning core may employ various types of neural network architectures, such as Convolutional Neural Networks (CNNs), You Only Look Once (YOLO) networks, Single Shot Detectors (SSD), Region-based CNNs (R-CNN and its variants), MobileNet, EfficientNet, or Vision Transformer (ViT) models. Each of these architectures has its own strengths and characteristics suited for image and video processing tasks, offering different trade-offs between accuracy, processing speed, and computational requirements. The choice of architecture depends on factors such as the specific requirements of the logo detection task, available resources, and the nature of the input data. Regardless of the specific implementation, the deep learning core plays a crucial role in transforming visual input into meaningful logo identifications, forming the foundation of advanced logo recognition systems.

### Conceptual Architecture

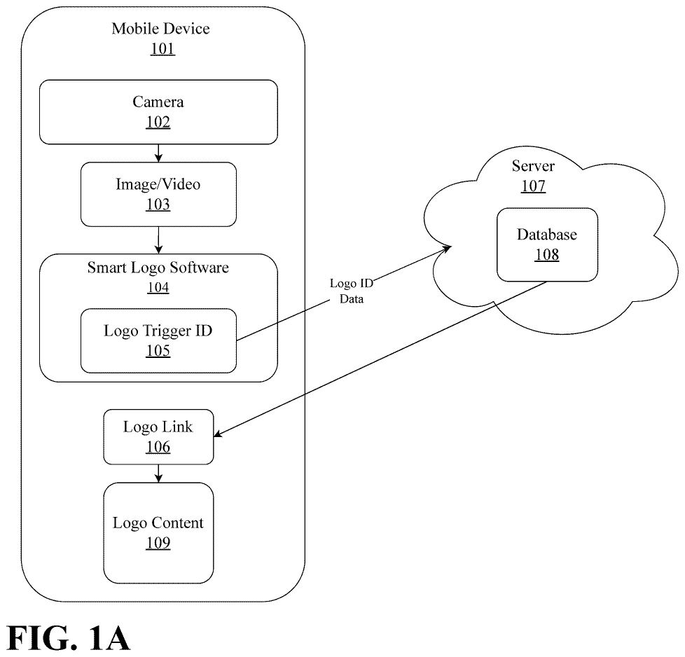

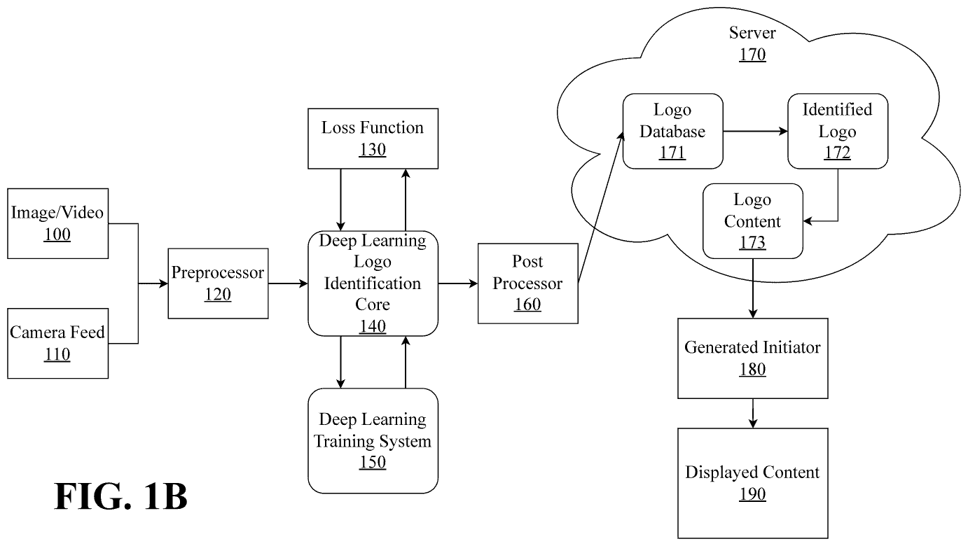

FIG. 1A is a block diagram illustrating an exemplary system architecture of a system for a smart logo platform. At the core of this system is a mobile device 101, which serves as the primary interface for users to interact with the smart logo technology. This mobile device is generally equipped with a camera 102 or has access to camera software that can capture images or videos. The camera 102 functionality is crucial as it allows users to either take live photos or videos of logos in their environment or access previously captured media from the device's storage.

The system begins its operation when an image or video 103 is obtained, either through real-time capture using the device's camera or by selecting existing media from the device's gallery. This visual input serves as the raw data for the logo recognition process. The captured or selected image/video is then processed by a smart logo software 104, which may be installed on the mobile device 101 or may be incorporated into an application. This software employs sophisticated object detection algorithms specifically trained to identify a wide array of logos. The training corpus for this software encompasses a diverse set of logo images, enabling it to recognize logos across various industries, styles, and contexts. When the smart logo software 104 analyzes the input image or video 103, it performs a pattern matching process against its trained model. The outcome of this analysis is binary: either the software does not detect any known logo within the input, or it successfully identifies a logo and generates a corresponding logo trigger ID 105. This ID 105 is a unique identifier associated with the recognized logo, serving as a key to retrieve further information and initiate subsequent actions.

If a logo is successfully identified, the system proceeds to the next stage of the process. The logo trigger ID is transmitted to a server 107, which acts as the central hub for storing and managing logo-related data and content. This server houses a comprehensive database 108 that contains a wealth of information associated with each recognizable logo. The database is structured to efficiently map logo IDs to their corresponding interactive elements and content. Upon receiving the logo trigger ID, the server queries its database to retrieve the associated logo link 106. This logo link serves as an initiator—an interactive element that, when presented to the user, enables further engagement with the brand or product associated with the recognized logo. The logo link could take various forms, such as a clickable URL, a deep link to a specific app function, or a call-to-action button.

When the user interacts with the presented logo link the user triggers the retrieval and display of logo content 109 on the mobile device. The nature of this content can vary widely depending on the brand's objectives and the specific campaign associated with the logo. It might include product information, promotional offers, interactive experiences, or in some cases, a pre-populated text message ready to be sent via the device's messaging application.

This system architecture enables a seamless flow from logo recognition to user engagement, creating an interactive bridge between physical branding elements and digital experiences. By leveraging the ubiquity of mobile devices and the power of advanced image recognition technology, this platform offers brands a novel way to connect with consumers and provide them with relevant, timely, and engaging content directly through their smartphones.

To give an example of the system in action, imagine a user snaps a picture of a new BMW vehicle. Using the camera, the user captures an image or video 103 of the BMW logo on the car's hood. Alternatively, if the user had previously taken a photo of a BMW billboard, they could select this image from their device's gallery. This flexibility allows for both real-time interactions and engagement with previously encountered logos. The captured image or video is then passed to the smart logo software 104 installed on the device. This software 104 may be a simple image recognition tool but in some embodiment may be a sophisticated AI-powered system trained on a vast corpus of logo designs. For BMW alone, the software might be trained on hundreds of variations of the iconic blue and white roundel, accounting for different angles, lighting conditions, and even slight design evolutions over the years.

As the software analyzes the input, it may employ advanced convolutional neural networks to detect and classify the logo. In our BMW example, the software would identify the circular shape, the distinctive quadrants, and the specific blue and white color pattern characteristic of the BMW logo. Upon successful identification, the software may generate a unique logo trigger ID 105 for BMW, let's say “BMW_001”. This logo trigger ID is then securely transmitted to the server 107. The transmission is encrypted to protect user privacy and prevent data interception. The server receives the “BMW_001” ID and immediately initiates a database query. The logo ID database 108 may be a relational database structure that not only stores logo identifiers but also contains a wealth of associated data. For BMW, this might include different marketing campaigns, regional promotions, and various call-to-action options. The database quickly matches “BMW_001” with the current active campaign for BMW.

Based on the campaign parameters, the server selects an appropriate logo link 106. In this case, let's say BMW is running a promotion for test drives of their new electric vehicles. The server generates a deep link that, when activated, will open the user's default messaging app with a pre-populated message to schedule a test drive. This logo link 106 is sent back to the mobile device and presented to the user, perhaps as an overlay on the camera view or as a notification. The user, intrigued by the opportunity, taps on the link. This interaction triggers the retrieval of the specific logo content 109 from the server.

In this example, the logo content is a carefully crafted, personalized message that opens in the user's messaging app. It might read: “Experience the future of driving with BMW's new electric lineup. Reply ‘YES’ to schedule a test drive at your nearest dealership, or ‘CALL’ to speak with a BMW representative.” This message is not just plain text, but could include rich media elements like a gif of the car model or a map showing the nearest BMW dealership. If the user replies ‘YES’, this could trigger another server interaction to access BMW's booking system and suggest available time slots. If they choose ‘CALL’, the app could initiate a call to a BMW call center, with the representative already briefed on the user's interest in electric vehicles based on the interaction.

This entire process, from the moment the user points their camera at the BMW logo to the point where they're scheduling a test drive or speaking with a representative, happens within seconds. It creates a seamless bridge between the physical world (the BMW logo on a car or billboard) and the digital realm of personalized, immediate customer engagement. Through this system, BMW has transformed a simple logo sighting into a potential sales opportunity, providing value to the customer by offering an easy way to engage with the brand at the moment of highest interest. This example demonstrates how each component of the system—from the mobile device and its camera to the AI software, the server, the database, and the content delivery mechanism-works in concert to create a powerful, real-time marketing and customer engagement tool.

FIG. 1B is a block diagram illustrating an exemplary advanced system architecture of a system for a smart logo platform. The system begins with an input source 100, which can be either a static image, a video file, or a live camera feed 110 from the user's mobile device. This flexibility allows the system to operate in various scenarios, from analyzing existing media to providing real-time interactions based on what the user's camera is currently viewing. The system may be designed to efficiently handle live camera feed input, enabling real-time logo detection and user engagement. When processing a live camera feed, the platform may employ a frame-by-frame analysis approach, optimized for mobile devices to balance performance and battery consumption. The camera feed is typically captured at 30 frames per second, however to reduce computational load, in one embodiment the system may processes every third frame, effectively analyzing 10 frames per second. This sampling rate provides a good balance between responsiveness and resource utilization.

As each frame is captured, it undergoes rapid preprocessing. The preprocessed frame is then passed through the trained deep learning logo identification model. To optimize this process for live feed analysis, the system employs a technique called model pruning, where less important neurons in the neural network are removed, reducing computational complexity while maintaining accuracy. Additionally, the system uses quantization-aware training, allowing the model to operate with 8-bit integer weights instead of 32-bit floating-point numbers, further reducing memory usage and inference time.

To enhance the user experience and reduce jitter in logo detection, the system may implement a temporal smoothing algorithm. When a logo is detected in the current frame, its bounding box coordinates and confidence score are compared with the buffered detections. If the current detection significantly differs from the recent history, it is temporarily ignored to prevent flickering or false positives. This approach ensures that logos are consistently tracked across multiple frames before triggering any user interaction.

The live feed processing may also incorporate an adaptive frame skipping mechanism. During periods of rapid camera movement, detected through the device's accelerometer and gyroscope data, the system temporarily increases the frame skip rate to conserve resources. Conversely, when the camera is relatively stable, the frame processing rate is increased to improve responsiveness. This dynamic adjustment helps maintain a smooth user experience across various usage scenarios. To handle scenarios where multiple logos are present in the camera feed simultaneously, the system may employ a priority queue based on logo size and confidence score. The top N logos (where N may initially be set to 3) are tracked and processed in parallel. This allows the system to prepare content for multiple detected logos, enabling quick switching between different brand interactions as the user moves the camera.

Lastly, to ensure privacy and reduce unnecessary data transmission, all live feed processing may occur on the device itself. Only when a logo is confidently detected and the user chooses to interact with it does the system communicate with the server to retrieve personalized content. This approach not only protects user privacy but also minimizes data usage and reduces latency in the logo recognition process.

The input data first passes through a preprocessor 120. This subsystem prepares the raw visual data for efficient and accurate analysis. The preprocessor may perform several operations, such as resizing the image to a standard dimension (e.g., 224×224 pixels), normalizing pixel values to a specific range (e.g., 0 to 1), or applying image enhancement techniques like contrast adjustment or noise reduction. For video or live camera feeds, the preprocessor might also handle frame extraction, selecting key frames for analysis to balance processing speed and accuracy. These preprocessing steps ensure that the subsequent deep learning model receives consistent and optimized input, regardless of the original source's characteristics.

The preprocessed data then flows into the heart of the system: a deep learning logo identification core 140. This module leverages state-of-the-art convolutional neural network (CNN) architectures, such as but not limited to ResNet, Inception, or MobileNet, specifically trained for logo detection and recognition. The core might employ a two-stage approach: first, an object detection model identifies regions of interest that potentially contain logos, and then a classification model determines the specific logo within each region. For instance, the object detection stage might identify a swoosh-shaped region in a sneaker image, which the classification stage then recognizes as the Nike logo.

The deep learning core 140 is continually refined through a deep learning training system 150. This training system 150 uses a carefully curated dataset of diverse logo images, including variations in lighting, angle, and context. The training process employs a loss function 130, such as cross-entropy loss for classification or mean squared error for bounding box regression, to measure the model's performance and guide its improvement. The training system 150 might also incorporate techniques like transfer learning, starting with a model pre-trained on a large image dataset and fine-tuning it for logo recognition, or data augmentation to artificially expand the training set with transformed versions of existing logo images.

The deep learning core 140 can be implemented using various neural network architectures and approaches, each with its own strengths and trade-offs. One common approach is to use a two-stage architecture, where the first stage employs an object detection network such as Faster R-CNN, YOLO (You Only Look Once), or SSD (Single Shot Detector) to identify regions of interest that potentially contain logos. These regions are then passed to a second-stage classification network, which could be a deep convolutional neural network (CNN) like ResNet, Inception, or DenseNet, fine-tuned specifically for logo classification. This two-stage approach allows for high accuracy but may have higher computational requirements. Alternatively, a single-stage approach could be used, where a network like YOLO v4 or EfficientDet is trained to simultaneously detect and classify logos in a single forward pass, offering faster inference times at the potential cost of some accuracy. Another architecture might leverage a feature pyramid network (FPN) to handle logos of varying sizes more effectively, combining features from different scales of the input image to make predictions.

For scenarios where computational resources are limited, such as on mobile devices, the core 150 might employ lightweight architectures like MobileNetV3 or EfficientNet, which are designed to balance accuracy and efficiency. These models use techniques like depthwise separable convolutions and squeeze-and-excitation blocks to reduce parameter count and computational complexity while maintaining high accuracy. In cases where the system needs to recognize a large number of logos, a few-shot learning approach could be implemented. This might involve using a Siamese network or prototypical network architecture, allowing the system to recognize new logos with only a few examples, which is particularly useful for rapidly expanding the logo database without extensive retraining. Additionally, the core 150 could incorporate attention mechanisms, such as those used in transformer architectures, to focus on the most relevant parts of the image for logo detection. This can be especially helpful in cluttered or complex scenes where logos may be partially obscured or distorted. Regardless of the specific architecture chosen, the logo identification core 150 may be trained using a combination of large-scale logo datasets and data augmentation techniques to ensure robustness to various real-world conditions such as different lighting, angles, and contexts in which logos might appear.

Once the deep learning core 150 processes the input, the results undergo post-processing 160. This subsystem refines the raw outputs of the neural network to produce more reliable and usable results. Post-processing might include non-maximum suppression to eliminate redundant detections, confidence thresholding to filter out low-confidence predictions, or ensemble methods that combine outputs from multiple models for improved accuracy. For example, if the system detects multiple instances of a Starbucks logo in a single image, post-processing would ensure that only the most confident detections are retained and that overlapping detections are merged.

The post-processed results are then sent to a server 170 for further analysis and action determination. The server hosts a comprehensive logo database 171 containing information about a wide range of logos, including their visual characteristics, associated brands, and linked actions or content. The system compares the identified logo 172 from the input against this database to find the most likely match. This matching process might use techniques like feature vector comparison or similarity scoring to identify the closest match, even if the detected logo is slightly distorted or partially obscured.

Once a match is found, the server retrieves the associated logo content 173 from its database. This content is customized for each logo and brand, potentially including marketing messages, product information, special offers, or interactive experiences. For instance, if the system recognizes a Coca-Cola logo, the associated content might include a link to a current promotional campaign, nutritional information, or an interactive game themed around the brand.

Based on the retrieved logo content, the system generates an initiator 180 which is presented to the user on their device. This initiator serves as an interactive bridge between the physical logo and the digital experience. It could take various forms, such as a deeplink to a messaging app with a pre-composed message, a URL for a webpage with more information about the product, or a phone number linked to the user's phone application for easy customer service access. For example, recognizing a McDonald's logo might generate an initiator that opens the McDonald's app to the current special offers page, or creates a pre-filled message in a messaging app to share a “buy one, get one free” deal with friends.

When the user interacts with the initiator, the system generates and displays content 190 on the user's device. This content is directly associated with the identified logo and can include a wide range of options. It might be a pre-populated message in a messaging app asking about product availability, a phone number ready to dial for customer support, a webpage with detailed product specifications, a digital coupon for immediate use, or an augmented reality experience that overlays digital content onto the physical world viewed through the device's camera. For instance, interacting with an initiator generated from a Lego logo might launch an AR experience showing a 3D model of the completed set built from the box in view.

This comprehensive system architecture enables a seamless flow from logo recognition to user engagement, creating an interactive and personalized experience based on the visual input of logos in the user's environment. By combining advanced computer vision techniques with cloud-based content delivery and mobile interaction design, the system bridges the gap between physical branding and digital engagement, offering brands new ways to connect with consumers and providing users with instant, relevant information and experiences tied to the logos they encounter in their daily lives. For exemplary pseudocode using PyTorch for a smart logo platform, see APPENDIX A.

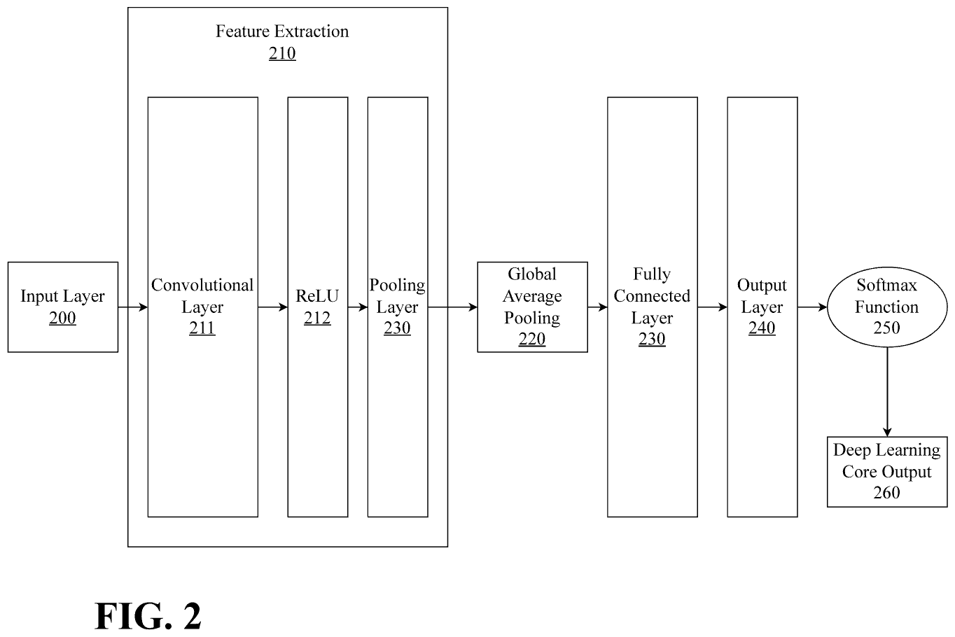

FIG. 2 is a block model illustrating an aspect of a system for a smart logo platform, a deep learning logo identification core. The deep learning logo identification core begins with an input layer 200, which receives the preprocessed image data. This input could be, for example, a 224×224 pixel RGB image of a sneaker featuring a prominent swoosh design. The input layer serves as the entry point for the raw pixel values, normalized to a specific range (typically 0 to 1) to facilitate efficient processing by subsequent layers.

The input then flows into a feature extraction stage 210. This stage typically consists of a plurality of convolutional layers 211, each followed by a plurality of ReLU (Rectified Linear Unit) activation functions 212. The convolutional layers apply a set of learnable filters to the input, sliding these filters across the spatial dimensions of the image to produce feature maps. Each filter is designed to detect specific patterns or features in the input. As our sneaker image passes through these layers, the network learns to detect increasingly complex features. The first convolutional layer might identify simple edges and curves in the sneaker image, while subsequent layers combine these basic features to recognize more complex patterns like the distinctive swoosh shape. The ReLU activation function introduces non-linearity into the system, allowing the network to learn more complex relationships. It operates by setting all negative values to zero while keeping positive values unchanged, effectively enabling the network to model non-linear decision boundaries. A ReLU is just one example of an activation function. A plurality of activation functions may be used depending on the requirements of the system and the complexity of the images being processed.

Interspersed between these convolutional layers are a plurality of pooling layers 230, which downsample the spatial dimensions of the features. Common pooling operations include max pooling, which selects the maximum value from a local neighborhood of the feature map. This downsampling helps to make the network more robust to slight variations in logo position and size, as well as reducing the computational load and number of parameters in the network. For the sneaker image example, pooling layers might help the network recognize the Nike swoosh regardless of its exact position or size within the image.

After the feature extraction process, the core 140 employs a global average pooling layer 220. This layer takes the final feature maps and reduces each to a single value by computing the average of all spatial locations. For the sneaker image example, this might result in a compact vector where each element represents the average activation of a particular high-level feature across the entire image. This step helps to significantly reduce the number of parameters in the network, mitigating the risk of overfitting and making the model more generalizable to new, unseen logo images.

The pooled features then pass through one or more fully connected layers 230. In these layers, every neuron is connected to every neuron in the previous layer, allowing the network to learn complex combinations of the high-level features extracted by the convolutional layers. These layers effectively translate the visual patterns into more abstract concepts. In the present example, this is where the network might learn to associate the combination of a curved swoosh shape with other characteristic features of Nike branding, such as specific color schemes or text styles. The fully connected layers progressively refine the feature representation, distilling the most relevant information for the final classification task.

The final layer of the core 140 is an output layer 240, which has as many neurons as there are logo classes in our database. Each neuron in this layer corresponds to a specific logo brand. The activations of this layer represent the network's confidence in the presence of each logo class. For the sneaker image example, it's expected that the neuron corresponding to the Nike logo to have a high activation, while neurons representing other brands would have lower activations.

These raw confidence scores are then passed through a softmax function 250, which normalizes them into a probability distribution. The softmax function exponentiates each input and then normalizes these values so that they sum to 1. This step ensures that all the output values are between 0 and 1, and they sum to 1, allowing us to interpret them as probabilities. In our Nike sneaker example, we might see a very high probability (say, 0.98) for the Nike logo class, with much lower probabilities distributed among other sports brand logos. Finally, the system produces its deep learning core output 260, which typically includes the predicted logo class (in the example, Nike) along with its confidence score. This output can then be used by subsequent parts of the system for further processing, such as retrieving relevant content or generating user interactions based on the identified logo.

Throughout this process, each layer builds upon the output of the previous layer, gradually transforming the raw pixel values of our input sneaker image into increasingly abstract and task-relevant features. The convolutional and pooling layers work together to extract and refine visual features, while the fully connected layers learn to combine these features in ways that are optimal for logo classification. The softmax function then provides a probabilistic interpretation of the network's final output. Through this sequence of operations, our input image of a sneaker has been transformed into a high-confidence identification of the Nike logo, demonstrating the power and sophistication of the deep learning core in logo recognition tasks.

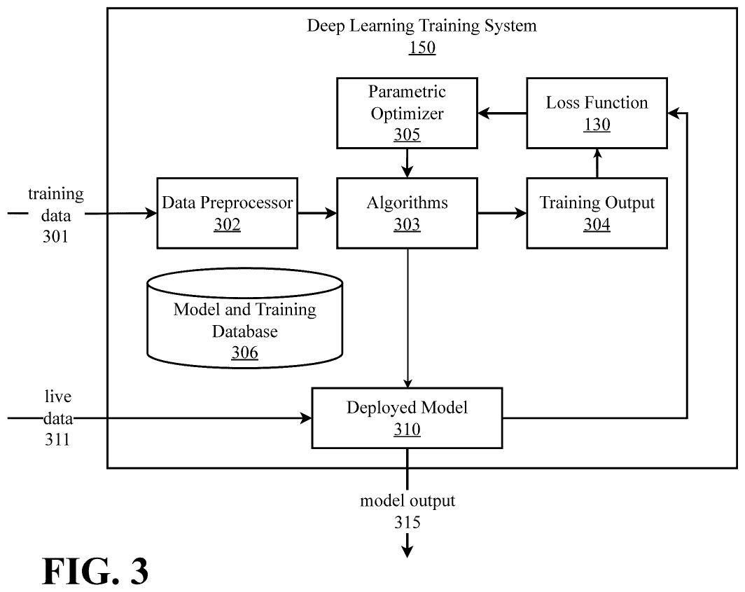

FIG. 3 is a block model illustrating an aspect of a system for a smart logo platform, a deep learning training system. According to the embodiment, the deep learning training system 150 may comprise a model training stage comprising a data preprocessor 302, one or more machine and/or deep learning algorithms 303, training output 304, and a parametric optimizer 305, and a model deployment stage comprising a deployed and fully trained model 310 configured to perform tasks described herein such as processing images through a deep learning logo identification core. The deep learning training system 150 may be used to train and deploy a plurality of deep learning architectures in order to support the services provided by the deep learning logo identification core. In one embodiment, machine learning training system 150 may be used to train the deep learning logo identification core 140. If the deep learning logo identification core 140 comprises a plurality of different deep learning architectures, the deep learning training system 150 may train each of the deep learning architectures separately or together as a single system.

At the model training stage, a plurality of training data 301 may be received by the deep learning logo identification core 140. Data preprocessor 302 may receive the input data (images, videos, individual frames of a live camera feed) and perform various data preprocessing tasks on the input data to format the data for further processing. For example, data preprocessing can include, but is not limited to, tasks related to data cleansing, data deduplication, data normalization, data transformation, handling missing values, feature extraction and selection, mismatch handling, and/or the like. Data preprocessor 302 may also be configured to create training dataset, a validation dataset, and a test set from the plurality of input data 301. For example, a training dataset may comprise 80% of the preprocessed input data, the validation set 10%, and the test dataset may comprise the remaining 10% of the data. The preprocessed training dataset may be fed as input into one or more machine and/or deep learning algorithms 303 to train a predictive model for object monitoring and detection.

During model training, training output 304 is produced and used to measure the accuracy and usefulness of the predictive outputs. During this process a parametric optimizer 305 may be used to perform algorithmic tuning between model training iterations. Model parameters and hyperparameters can include, but are not limited to, bias, train-test split ratio, learning rate in optimization algorithms (e.g., gradient descent), choice of optimization algorithm (e.g., gradient descent, stochastic gradient descent, of Adam optimizer, etc.), choice of activation function in a neural network layer (e.g., Sigmoid, ReLu, Tanh, etc.), the choice of cost or loss function the model will use, number of hidden layers in a neural network, number of activation unites in each layer, the drop-out rate in a neural network, number of iterations (epochs) in a training the model, number of clusters in a clustering task, kernel or filter size in convolutional layers, pooling size, batch size, the coefficients (or weights) of linear or logistic regression models, cluster centroids, and/or the like. Parameters and hyperparameters may be tuned and then applied to the next round of model training. In this way, the training stage provides a machine learning training loop.

In some implementations, various accuracy metrics may be used by the deep learning training system 150 to evaluate a model's performance. Metrics can include, but are not limited to, word error rate (WER), word information loss, speaker identification accuracy (e.g., single stream with multiple speakers), inverse text normalization and normalization error rate, punctuation accuracy, timestamp accuracy, latency, resource consumption, custom vocabulary, sentence-level sentiment analysis, multiple languages supported, cost-to-performance tradeoff, and personal identifying information/payment card industry redaction, to name a few. In one embodiment, the system may utilize a loss function 130 to measure the system's performance. The loss function 130 compares the training outputs with an expected output and determined how the algorithm needs to be changed in order to improve the quality of the model output. During the training stage, all outputs may be passed through the loss function 130 on a continuous loop until the algorithms 303 are in a position where they can effectively be incorporated into a deployed model 315.

The test dataset can be used to test the accuracy of the model outputs. If the training model is establishing correlations that satisfy a certain criterion such as but not limited to quality of the correlations and amount of restored lost data, then it can be moved to the model deployment stage as a fully trained and deployed model 310 in a production environment making predictions based on live input data 311 (e.g., images, videos, individual frames from a live camera feed). Further, model correlations and restorations made by deployed model can be used as feedback and applied to model training in the training stage, wherein the model is continuously learning over time using both training data and live data and predictions. A model and training database 306 is present and configured to store training/test datasets and developed models. Database 306 may also store previous versions of models.

According to some embodiments, the one or more machine and/or deep learning models may comprise any suitable algorithm known to those with skill in the art including, but not limited to: LLMs, generative transformers, transformers, supervised learning algorithms such as: regression (e.g., linear, polynomial, logistic, etc.), decision tree, random forest, k-nearest neighbor, support vector machines, Naïve-Bayes algorithm; unsupervised learning algorithms such as clustering algorithms, hidden Markov models, singular value decomposition, and/or the like. Alternatively, or additionally, algorithms 303 may comprise a deep learning algorithm such as neural networks (e.g., recurrent, convolutional, long short-term memory networks, etc.).

In some implementations, the deep learning training system 150 automatically generates standardized model scorecards for each model produced to provide rapid insights into the model and training data, maintain model provenance, and track performance over time. These model scorecards provide insights into model framework(s) used, training data, training data specifications such as chip size, stride, data splits, baseline hyperparameters, and other factors. Model scorecards may be stored in database(s) 306.

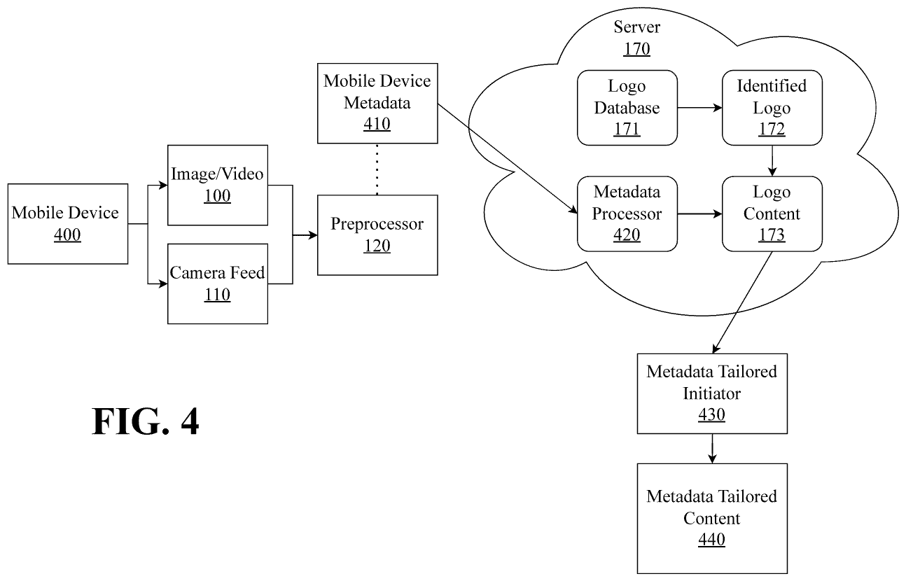

FIG. 4 is a block diagram illustrating an exemplary system architecture of a system for a smart logo platform, where the server processes user device metadata. In one embodiment, the system may leverage a rich set of metadata to tailor initiators and content, creating a highly personalized user experience. For example, the user's location data is not only used to determine their city but also to identify specific points of interest nearby. If a user scans a coffee shop logo near a university campus during exam season, the system might generate an initiator offering a student discount on caffeine-rich beverages. Time-based metadata may be utilized to adjust content based on the time of day, day of the week, and season. For instance, scanning a fast-food restaurant logo during breakfast hours might trigger a morning meal deal, while the same logo scanned in the evening could promote a family dinner package. The system may also track and analyze interaction history, including the frequency of logo scans, types of content engaged with, and purchase patterns. This data may be processed using a collaborative filtering algorithm to identify user preferences and suggest relevant content. For example, if a user frequently interacts with eco-friendly product information across various brands, the system prioritizes sustainability-related content when presenting initiators and content for newly scanned logos.

Device-specific metadata, such as screen size and processing capabilities, may be used to optimize content delivery and user interface elements. On high-end devices, the system might offer more complex AR experiences or high-resolution video content, while on lower-end devices, it could focus on text-based information and static images to ensure smooth performance. Additionally, the system considers contextual metadata such as weather conditions, local events, and trending topics on social media. For instance, if a user scans a sports apparel logo on a rainy day, the system might prioritize waterproof gear in its recommendations. The metadata analysis process employs a combination of rule-based systems and machine learning models, including decision trees for categorization and recurrent neural networks for sequence prediction, to continuously refine and improve the relevance of presented initiators and content.

The system begins with visual input, which can be either an image/video 100 or a live camera feed 110 from a mobile device 400. For instance, a user might snap a photo of a Starbucks storefront or capture a McDonald's logo in a video of a busy street. This visual data undergoes initial processing in the preprocessor 120, which not only prepares the image for logo detection but also extracts valuable mobile device metadata 410. Metadata extraction may include a wide range of contextual information such as the device's GPS coordinates, the time and date of image capture, the user's interaction history with various logos, and even device-specific information like model and operating system. For example, the system might note that the image was captured at 8:30 AM in downtown Seattle, using an iPhone 12 with iOS 15, and that the user has interacted with coffee shop logos three times in the past week.

Once extracted, the mobile device metadata is passed through a metadata processor 420. This component analyzes and structures the metadata, preparing it for integration with the logo recognition results. The processed metadata is then sent to the server 170, along with the preprocessed image data. The server houses the logo database 171, which contains information about known logos. When an identified logo 172 is matched within the database, the system retrieves the corresponding logo content 173. However, this advanced architecture doesn't stop at basic content retrieval. Instead, it uses the processed metadata to tailor both the initiator and the content to the user's specific context.

For example, if the metadata indicates that the user is in Seattle, and the identified logo is Starbucks, the system might generate a metadata tailored initiator 430 that references a limited-edition “Seattle Blend” coffee available only in local stores. If the time and date information suggests it's morning, the initiator might prioritize breakfast menu items or morning coffee promotions. Furthermore, if the metadata shows that the user has frequently interacted with initiators for coffee shop logos, the system might generate a more sophisticated initiator, such as an augmented reality experience showing the coffee-making process.

Similarly, the system produces metadata tailored content 440 based on the combination of logo information and user metadata. Continuing with the Starbucks example, a user in Seattle during winter might receive content showcasing seasonal hot beverages and warm pastries. A user with a history of frequent interactions might receive loyalty rewards information or an exclusive offer for a free size upgrade. The time of day could influence whether the content emphasizes breakfast sandwiches or afternoon pick-me-up snacks.

This metadata-driven approach allows for a highly personalized user experience. Each interaction with a logo becomes an opportunity for contextually relevant engagement. For instance, if a user captures a Nike logo in the evening after previously interacting with fitness-related content, the system might generate an initiator linking to nighttime running gear or local evening jogging groups. The subsequent content could include personalized workout plans or community fitness challenges based on the user's location and activity history.

The integration of metadata processing into the logo recognition system represents a significant advancement in the field of mobile marketing and user engagement. It transforms what could be a simple logo identification tool into a sophisticated, context-aware platform capable of delivering highly personalized experiences. This approach not only enhances the relevance of the content delivered to users but also provides valuable insights for brands, allowing them to refine their marketing strategies based on real-world user interactions and contexts. For example, a brand might discover that users in certain locations are more likely to engage with their logo during specific times of day, informing future marketing campaigns and product offerings.

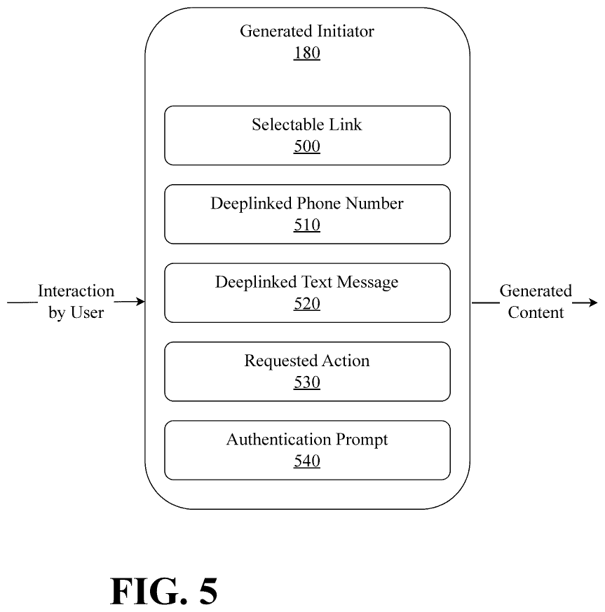

FIG. 5 is a block diagram illustrating an exemplary aspect of a system for a smart logo platform, a generated initiator. Initiators 180 may comprise a plurality of various forms that are presented to users as part of the logo recognition and engagement system. These initiators serve as interactive elements that, when activated by the user, trigger the display of specific content or actions related to the recognized logo. The figure outlines several possible types of initiators, each designed to facilitate different forms of user engagement.

One type of initiator is the selectable link 500, which could be a URL or a deep link within an app. For example, if a user scans a Nike logo, the generated initiator might be a link that opens the Nike app directly to a page featuring the latest shoe collection. Alternatively, for a movie studio logo, the link could lead to a trailer for an upcoming film. The deeplinked phone number 510 initiator allows for immediate communication with the brand. Upon interaction, it could automatically open the user's phone app with a pre-dialed number, perhaps connecting them to customer service or a promotional hotline. For instance, scanning a pizza delivery chain's logo might generate an initiator that, when tapped, calls the nearest outlet to place an order.

The deeplinked text message 520 initiator prepopulates a messaging app with specific content. This could be particularly useful for sharing promotions or participating in text-based services. For example, scanning a concert venue's logo might generate an initiator that, when activated, opens a messaging app with a pre-written text to purchase tickets for an upcoming show. The requested action 530 initiator prompts the user to perform a specific task, such as sharing their location to find nearby stores or accessing their camera to participate in an augmented reality experience. An authentication prompt 540 initiator might be used when the content requires user verification, such as age-restricted products or members-only offers.

Beyond these examples, other potential initiators could include a social media share button that prepopulates a post about the brand, a calendar event creator for upcoming sales or events, or a mini-game launcher for promotional content. An augmented reality initiator could overlay digital content onto the real world when viewed through the device's camera, while a loyalty program initiator might allow quick access to points balance or rewards.

The process of initiator generation, user interaction, and content display is a seamless flow designed to provide an engaging user experience. When a logo is recognized, the system generates an appropriate initiator based on factors such as the logo's associated brand, user preferences, location, time of day, and previous interactions. This generated initiator is then presented to the user, often as an overlay on the camera feed or as a pop-up notification. When the user interacts with the initiator, typically through a tap or swipe gesture, it triggers the corresponding action. This action could be opening a specific app page, initiating a call, preparing a message, or launching an interactive experience. Following this interaction, the system displays the generated content, which is tailored to both the recognized logo and the user's context. This content could range from product information and promotional offers to interactive experiences and personalized recommendations, all designed to provide value and encourage further engagement with the brand.

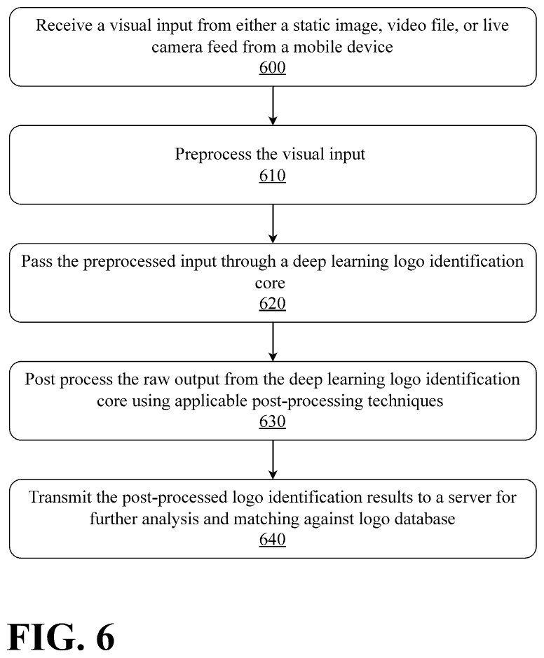

FIG. 6 is a flow diagram illustrating an exemplary method for a smart logo platform. In a first step 600, receive a visual input from a static image, a video file, or a live camera feed from a mobile device. This flexibility allows the system to accommodate different user scenarios and input types. For instance, a user might upload a photograph containing a logo, submit a video clip featuring multiple brand images, or point their smartphone camera at a storefront sign in real-time.

In a step 610, preprocess the visual input. This step prepares the raw visual data for efficient and accurate analysis by the logo identification core. Preprocessing may involve several operations such as resizing the image to a standardized dimension (e.g., 224×224 pixels), normalizing pixel values to a specific range (typically 0 to 1), and applying various image enhancement techniques. These techniques could include adjusting brightness and contrast, reducing noise, or applying color corrections. For video inputs or live camera feeds, this step might also involve frame extraction or selection to identify key frames for analysis. The goal of preprocessing is to ensure that the subsequent deep learning model receives consistent and optimized input, regardless of the original source's characteristics.

In a step 620, the preprocessed input is passed through a deep learning logo identification core. This core is the heart of the logo detection system, typically consisting of a sophisticated neural network architecture trained on a vast dataset of logo images. The deep learning model applies multiple layers of analysis to the input, progressively extracting more complex and abstract features. In the case of logo detection, early layers might identify basic shapes and edges, while deeper layers recognize specific logo patterns and characteristics. The output of this core is a set of predictions about the presence and identity of logos in the input image or video frame.

In a step 630, the system applies post-processing techniques to the raw output 630. This step refines and interprets the results from the neural network to produce more reliable and usable logo detection outcomes. Post-processing might include techniques such as non-maximum suppression to eliminate redundant detections, confidence thresholding to filter out low-confidence predictions, or ensemble methods that combine outputs from multiple models for improved accuracy. For instance, if the system detects multiple instances of the same logo in close proximity, post-processing would ensure that only the most confident detection is retained.

In a step 640, the post-processed logo identification results are transmitted to a server for further analysis and matching against a logo database. This step moves the refined detection results from the local device or processing environment to a centralized server infrastructure. The server can then perform additional operations such as comparing the detected logo features against a comprehensive database of known logos, retrieving associated brand information, or preparing for subsequent steps in user engagement. This transmission to the server also allows for potential updates to the logo database and facilitates the collection of data that could be used to improve the logo detection system over time.

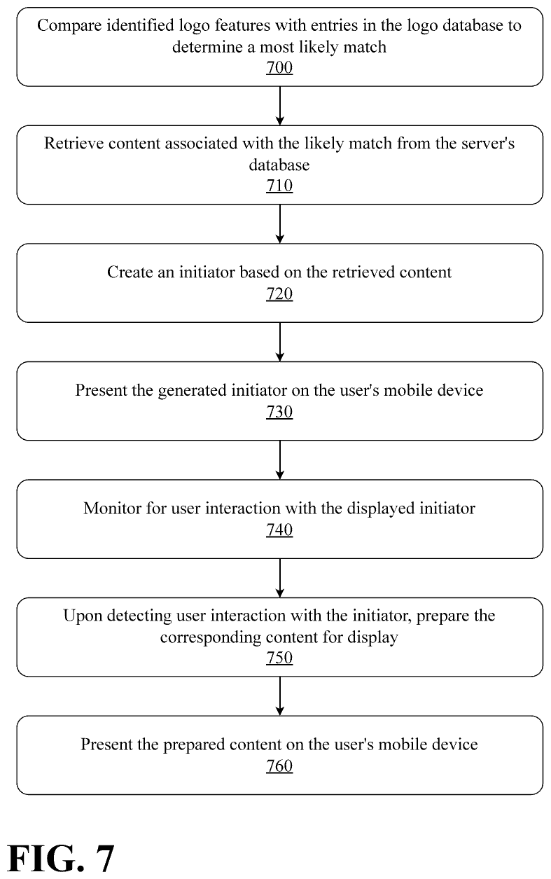

FIG. 7 is a flow diagram illustrating an exemplary method for displaying generated content to a user's device using a smart logo platform. In a first step 700, compare an identified logo features with entries in the logo database to determine the most likely match. This process utilizes sophisticated matching algorithms to compare the detected logo's characteristics against a vast database of known logos. For instance, if a swoosh-like shape is detected, the system might compare its specific curvature, proportions, and orientation against stored Nike logo data to confirm a match.

In a step 710, once a match is established, the system retrieves content associated with the likely match from the server's database. This content could encompass a wide range of materials, such as product information, promotional offers, brand stories, or interactive experiences. For example, if a Coca-Cola logo is identified, the retrieved content might include details about ongoing promotions, nutritional information, or brand-related games.

In a step 720, using this retrieved content, the system then creates an initiator. This initiator serves as an interactive element designed to engage the user and acts as a bridge between the physical logo and the digital experience. The initiator could take various forms, such as a clickable button, a swipeable card, or an augmented reality overlay. For instance, for a detected Starbucks logo, the initiator might be a button that says “View today's specials” or “Earn reward points.” In a step 730, the generated initiator is then presented on the user's mobile device. This presentation is designed to be noticeable yet unobtrusive, often appearing as an overlay on the camera feed or as a notification. The initiator's design and placement are crucial for encouraging user interaction while maintaining a smooth user experience.

In a step 740, following the presentation of the initiator, the system enters a monitoring phase, watching for user interaction with the displayed initiator. This could involve detecting a tap, swipe, or other gesture on the specific area of the screen where the initiator is displayed. The system remains in this state, ready to respond to any user action.

In a step 750, upon detecting user interaction with the initiator, the system springs into action to prepare the corresponding content for display. This preparation phase might involve formatting content to fit the device's screen, loading additional assets, or even generating dynamic content based on user context or preferences. For example, if a user interacts with an initiator for a clothing brand logo, the system might prepare a personalized lookbook based on the user's previous purchases or browsing history.

In a step 760, the system presents the prepared content on the user's mobile device. This could manifest in various ways, such as opening a dedicated page within an app, displaying a full-screen interactive experience, or overlaying information on the camera feed in an augmented reality format. For instance, interacting with a movie studio logo's initiator might result in the display of a trailer for an upcoming film, complete with local show times and a ticket purchasing option.

### DETAILED DESCRIPTION OF EXEMPLARY ASPECTS

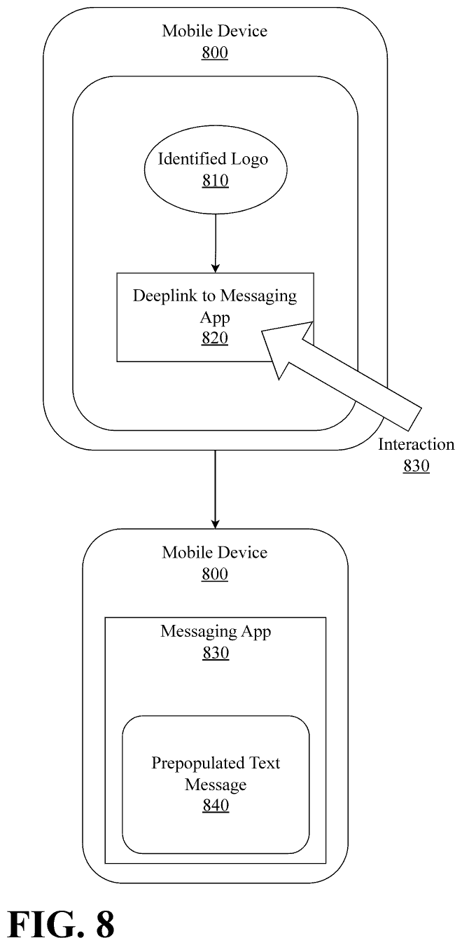

FIG. 8 is a block diagram illustrating exemplary generated content where the generated content is a deeplink to a messaging app. The process begins with a mobile device 800, which could be a smartphone or tablet, equipped with a camera and the necessary software for logo detection. As the user points their device's camera at various objects or environments, the system actively scans for recognizable logos.

When an identified logo 810 is detected within the camera's field of view, the system immediately responds by generating a deeplink to a messaging app 820. This deeplink serves as an initiator, presented to the user as an interactive element on their device's screen. It could appear as a something like a clickable button, a swipeable notification, or an overlay on the camera feed, depending on the application's design. The deeplink is specifically crafted to open a predetermined messaging application installed on the user's device, streamlining the transition from logo recognition to user engagement.

The next stage of the process is triggered by user interaction 830 with the presented deeplink. This interaction could be a simple tap, a swipe, or any other predefined gesture that the user performs on their device's touchscreen. Upon this interaction, the system activates the deeplink, which seamlessly opens the messaging app 830 on the mobile device.

Once the messaging app is launched, the user is presented with a prepopulated text message 840. This message is automatically generated based on the identified logo and potentially other contextual factors. For example, if the recognized logo belongs to a pizza delivery chain, the prepopulated message might include a standard order, a promotional code, or a query about current specials. This approach significantly reduces friction in the user experience, allowing for quick and easy communication with the brand associated with the detected logo.

It's important to note that while this figure outlines a specific example of an initiator (the deeplink to a messaging app) and corresponding content (the prepopulated text message), the system is capable of supporting various other types of initiators and content. Depending on the brand's preferences, user context, or campaign objectives, the initiator could instead be a link to a website, a prompt to call a phone number, or an invitation to view an augmented reality experience. Similarly, the corresponding content could range from product information pages and promotional videos to interactive games or social media sharing options. This flexibility allows brands to create diverse and engaging experiences tailored to their specific goals and target audiences, all triggered by the simple act of a user pointing their device at a logo.

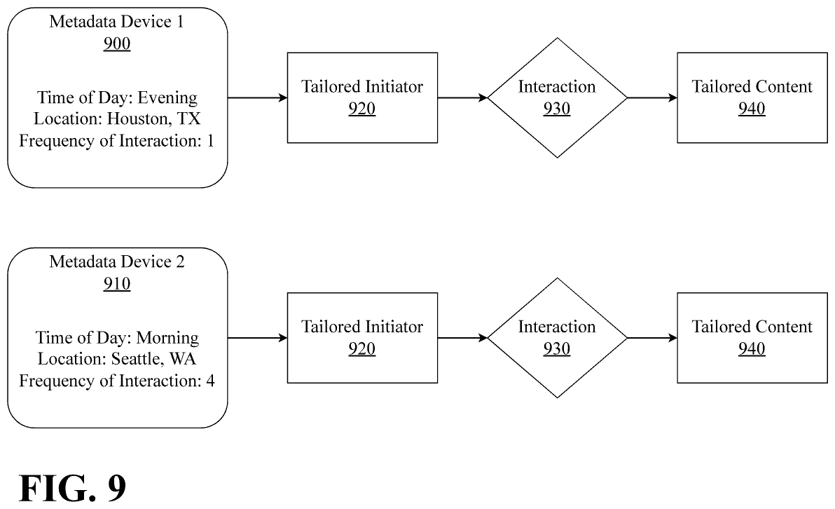

FIG. 9 is a block diagram illustrating an exemplary system for tailoring generated content to a user's associated metadata using a smart logo platform. The figure presents two distinct sets of metadata, each associated with a different mobile device. metadata device 1 900 shows a user in Houston, Texas, interacting with the system in the evening, with this being their first interaction. In contrast, metadata device 2 910 represents a user in Seattle, Washington, engaging with the system in the morning, with a history of four previous interactions. These metadata points, while not exhaustive, provide context for personalizing the user experience.

Based on these metadata differences, the system generates tailored initiators 920 for each device. For the Houston user, given its evening and their first interaction, the initiator might be a welcoming message with a dinner-themed promotion. For example, “Tap here to explore our evening specials!” Conversely, the Seattle user, being a morning interaction and a frequent user, might see an initiator like “Good morning! Your usual breakfast order is one tap away.” When users interact 930 with these tailored initiators, they are presented with tailored content 940 that further reflects their specific contexts. The Houston user, being new to the system, might receive content that introduces the brand's range of products or services, with a focus on popular evening choices in the local area. This could include a list of nearby restaurants open late or a selection of quick dinner recipes using the brand's products. On the other hand, the Seattle user, as a frequent interactor, might receive more personalized content. This could include a loyalty rewards update, a preview of new breakfast items, or even a personalized offer based on their previous orders. The morning context might also prompt content related to coffee promotions or grab-and-go breakfast options popular in Seattle.

It's important to note that while this figure focuses on time, location, and interaction frequency, real-world applications would likely incorporate many more metadata points. These could include points such as but not limited to user preferences, purchase history, weather conditions, or even current events in the user's location. By considering this rich tapestry of contextual information, the system can create highly personalized and relevant experiences for each user, significantly enhancing the effectiveness of logo-triggered interactions.

This metadata-driven approach allows brands to move beyond one-size-fits-all marketing, instead offering tailored experiences that resonate with users' immediate contexts and needs. Whether it's a first-time user in Houston exploring evening options or a loyal customer in Seattle starting their day, the system adapts to provide the most relevant and engaging content possible, all initiated by the simple recognition of a logo.

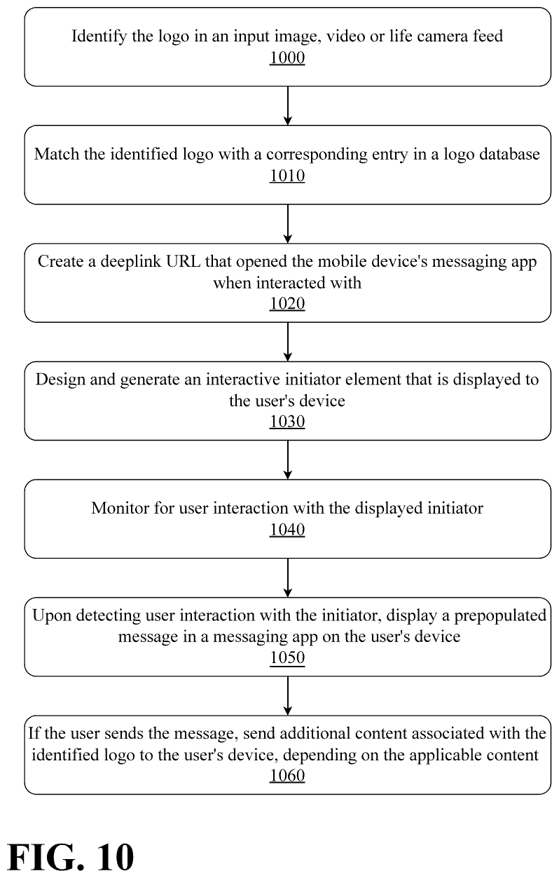

FIG. 10 is a flow diagram illustrating an exemplary method for generating a deeplink to a messaging app using a smart logo platform. In a first step 1000, the system identifies a logo within an input image, video, or live camera feed. This initial step employs advanced computer vision and machine learning algorithms to detect and recognize logos in various formats and contexts. For example, a user might point their smartphone camera at a coffee shop storefront, and the system would recognize the Starbucks logo on the sign. Alternatively, the logo could be identified in a uploaded photo of a Nike sneaker or a video of a Coca-Cola vending machine.

In a step 1010, the identified logo is matched with a corresponding entry in a logo database. This crucial step ensures that the detected visual element is accurately associated with the correct brand or company. For instance, once the Starbucks logo is detected, the system would match it with the Starbucks entry in its database, confirming the brand identity and accessing associated data such as brand colors, messaging templates, and current promotions.

In a step 1020, the system creates a deeplink URL specifically designed to open the mobile device's messaging app when interacted with. For example, if the recognized logo is Domino's Pizza, the deeplink might be structured to open the user's default SMS app with a specific phone number for ordering pizza. Alternatively, for a brand like Airbnb, the deeplink could be set to open Facebook Messenger to chat with customer support.

In a step 1030, an interactive initiator element is designed and generated, which is then displayed on the user's device. This initiator could take various forms depending on the application's design and the specific context of the logo recognition. For the Starbucks example, it might be a green button overlaid on the camera feed saying “Message for today's special.” For

Nike, it could be a swipeable card showing a picture of the detected sneaker with text saying “Share this shoe with friends.”

In a step 1040, the system enters a monitoring phase, actively watching for user interaction with the displayed initiator. This step ensures that the system remains responsive to user actions. The app might use event listeners to detect when the user taps the “Message for today's special” button or swipes the Nike sneaker card. In a step 1050, upon detecting user interaction with the initiator, the system displays a prepopulated message in a messaging app on the user's device. For Starbucks, this might open the user's SMS app with a message like “Hey! Starbucks has a buy-one-get-one-free deal on Frappuccinos today. Want to join me?” For Nike, it could open WhatsApp with a message saying “Check out these cool Nike Air Max I just saw! What do you think?” along with a link to the product page.

In a step 1060, if the user chooses to send the prepopulated message, the system responds by sending additional content associated with the identified logo to the user's device. For example, if the user sends the Starbucks message, they might receive a digital coupon for the promotion directly in the app. For Nike, after sharing the sneaker, the user might receive a notification with a special discount code for online purchases or information about a nearby Nike store where they can try on the shoes.

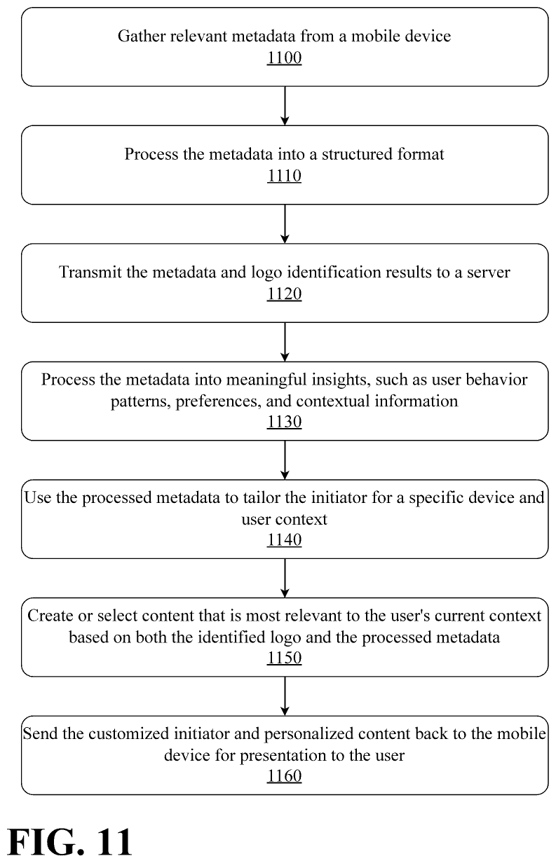

FIG. 11 is a flow diagram illustrating an exemplary method for tailoring generated content to a user's associated metadata using a smart logo platform. This approach enhances user engagement by tailoring both initiators and content to individual users and their specific circumstances. In a first step 1100, the system gathers relevant metadata from a mobile device. This could include a wide range of information such as the device's GPS location, time and date, device type, operating system version, language settings, and user interaction history. For example, the system might collect data indicating that the user is in New York City at 2 PM on a Wednesday, using an iPhone 12 with iOS 15, set to English language, and has interacted with coffee shop logos three times in the past week.

In a step 1110, the collected metadata is processed into a structured format. This step involves organizing the raw data into a standardized, easily analyzable form. For instance, the location data might be formatted as coordinates and city name, the time could be standardized to UTC, and the interaction history could be summarized as frequency counts for different logo categories. In a step 1120, the structured metadata, along with the results of the logo identification, is transmitted to a server. This could involve sending a data packet that includes both the recognized logo (e.g., Starbucks) and the formatted metadata to a cloud-based server for further processing and analysis.

In a step 1130, the server processes the metadata to extract meaningful insights about user behavior patterns, preferences, and contextual information. For our example, the system might infer that the user is a frequent coffee drinker, likely on a work break given the time and day, and possibly open to trying new coffee shops based on their interaction history. In a step 1140, the processed metadata is used to tailor the initiator for the specific device and user context. Given our example, the system might generate an initiator that says “Need an afternoon pick-me-up? Tap to see nearby coffee options!” This initiator is specifically designed to resonate with the user's current context and preferences.

In a step 1150, the system creates or selects content that is most relevant to the user's current context, based on both the identified logo and the processed metadata. Continuing our example, if the identified logo is indeed Starbucks, the content might include a map of nearby Starbucks locations, highlighting ones the user hasn't visited before. It could also feature a promotional offer for a new afternoon coffee blend, appealing to the user's apparent interest in trying different coffee options. In a step 1160, the customized initiator and personalized content are sent back to the mobile device for presentation to the user. In our scenario, the user would see the tailored initiator about the afternoon pick-me-up. If they interact with it, they would then be presented with the map of nearby Starbucks locations and the promotional offer for the new coffee blend.

### Exemplary Computing Environment

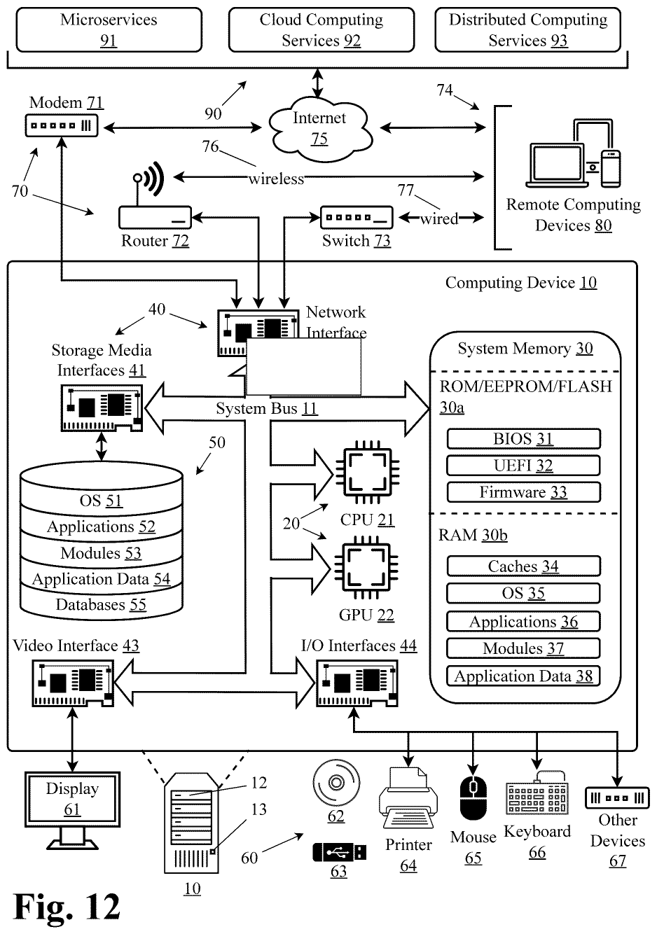

FIG. 12 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

APPENDIX A
EXEMPLARY PSEUDOCODE USING PYTORCH
FOR A SMART LOGO PLATFORM

```
import torch
import torchvision
from torchvision.models import efficientnet_b0
from torch.nn import functional as F
class SmartLogoPlatform:
  def _{——}init_{——}(self):
    self.logo_detector = self.build_logo_detector( )
    self.content_generator = self.build_content_generator( )
    self.logo_database = self.load_logo_database( )
  def build_logo_detector(self):
    # Use EfficientNet-B0 as the backbone
    backbone = efficientnet_b0(pretrained=True)
    # Modify the final layer for logo detection
    num_ftrs = backbone.classifier[1].in_features
    backbone.classifier[1] = torch.nn.Linear(num_ftrs, num_logo_classes)
    # Add Region Proposal Network
    rpn = torchvision.models.detection.rpn.RegionProposalNetwork(
      anchor_generator=torchvision.models.detection.rpn.AnchorGenerator(
        sizes=((32, 64, 128, 256, 512),),
        aspect_ratios=((0.5, 1.0, 2.0),)
      ),
      head=torchvision.models.detection.rpn.RPNHead(
        backbone.out_channels,
        anchor_generator.num_anchors_per_location( )[0]
      ),
      fg_iou_thresh=0.7,
      bg_iou_thresh=0.3,
      batch_size_per_image=256,
      positive_fraction=0.5,
    )
    # Combine backbone and RPN
    model = torchvision.models.detection.FasterRCNN(
      backbone,
      rpn,
      num_classes=num_logo_classes,
      box_roi_pool=torchvision.ops.MultiScaleRoIAlign(
        featmap_names=[‘0’], output_size=7, sampling_ratio=2
      )
    )
    return model
  def build_content_generator(self):
    # Simplified content generator using a transformer model
    model = torch.nn.Transformer(
      d_model=512, nhead=8, num_encoder_layers=6, num_decoder_layers=6
    )
    return model
  def load_logo_database(self):
    # Placeholder for logo database loading
    return { }
  def preprocess_image(self, image):
    # Resize and normalize the image
    transform = torchvision.transforms.Compose([
      torchvision.transforms.Resize((224, 224)),
      torchvision.transforms.ToTensor( ),
      torchvision.transforms.Normalize(
        mean=[0.485, 0.456, 0.406],
        std=[0.229, 0.224, 0.225]
      )
    ])
    return transform(image).unsqueeze(0)
  def detect_logo(self, image):
    preprocessed_image = self.preprocess_image(image)
    with torch.no_grad( ):
      predictions = self.logo_detector(preprocessed_image)
    return self.post_process_detections(predictions)
  def post_process_detections(self, predictions):
    # Apply NMS and confidence thresholding
    keep = torchvision.ops.nms(
      predictions[0][‘boxes'],
      predictions[0][‘scores'],
      iou_threshold=0.5
    )
    return predictions[0][‘boxes'][keep], predictions[0][‘labels'][keep],
predictions[0][‘scores'][keep]
  def generate_content(self, logo_id, user_metadata):
    # Retrieve logo information from database
    logo_info = self.logo_database.get(logo_id, { })
    # Combine logo info and user metadata
    input_data = self.prepare_input_data(logo_info, user_metadata)
    # Generate content using the transformer model
    with torch.no_grad( ):
      content = self.content_generator(input_data)
    return self.post_process_content(content)
  def prepare_input_data(self, logo_info, user_metadata):
    # Combine and encode logo info and user metadata
    # This is a placeholder and would need to be implemented based on specific requirements
    return torch.tensor([ ]) # Placeholder
  def post_process_content(self, content):
    # Decode the generated content and format it for display
    # This is a placeholder and would need to be implemented based on specific requirements
    return “” # Placeholder
  def process_image(self, image, user_metadata):
    boxes, labels, scores = self.detect_logo(image)
    if len(boxes) > 0:
      top_logo_id = labels[scores.argmax( )].item( )
      content = self.generate_content(top_logo_id, user_metadata)
      return content
    return None
# Usage example
platform = SmartLogoPlatform( )
image = load_image(“example.jpg”) # Placeholder function
user_metadata = {
  “location”: “New York”,
  “time”: “2023-06-21T14:30:00”,
  “device”: “iPhone 12”,
  “interaction_history”: [...]
}
result = platform.process_image(image, user_metadata)
if result:
  display_content(result) # Placeholder function
else:
  print(“No logo detected”)
```

What is claimed is:

1. A smart logo platform, comprising one or more computers with executable instructions that, when executed, cause the platform to:
receive an image, video, or live feed from a camera of a mobile device;
process the image, video, or live feed through a trained logo identification model to determine whether an identified logo is in the image, video, or live feed;
identify a plurality of IDs associated with the identified logos in the image, video or live feed;
cross-reference any identified IDs with a database, wherein the database comprises a plurality of IDs, a plurality of selectable initiators, and a plurality of content wherein each selectable initiator and content is associated with a specific ID;
display the selectable initiator associated with any identified IDs to the mobile device; and
display the content associated with any identified IDs to the mobile device when the selectable initiator is interacted with.

2. The system of claim 1, where the selectable initiator associated with the identified ID is a deeplink that opens a messaging app on the mobile device when selected by a user.

3. The system of claim 2, wherein the messaging app is prepopulated with a message that includes the content associated with the identified logo.

4. The system of claim 1, wherein the plurality of selectable initiators and the plurality of content is tailored to a plurality of metadata associated with the mobile device.

5. The system of claim 4, wherein the plurality of metadata includes current location of the mobile device, the date and time that an image, video, or live feed was received from the mobile device, and the frequency of a selectable initiator associated with a specific logo being interacted with on the mobile device.

6. A method for a smart logo platform, comprising the steps of:
receiving an image, video, or live feed from a camera of a mobile device;
processing the image, video, or live feed through a trained logo identification model to determine whether an identified logo is in the image, video, or live feed;
identifying a plurality of IDs associated with the identified logos in the image, video or live feed;
cross-reference any identified IDs with a database, wherein the database comprises a plurality of IDs, a plurality of selectable initiators, and a plurality of content wherein each selectable initiator and content is associated with a specific ID;
displaying the selectable initiator associated with any identified IDs to the mobile device; and
displaying the content associated with any identified IDs to the mobile device when the selectable initiator is interacted with.

7. The method of claim 6, where the selectable initiator associated with the identified ID is a deeplink that opens a messaging app on the mobile device when selected by a user.

8. The method of claim 7, wherein the messaging app is prepopulated with a message that includes the content associated with the identified logo.

9. The method of claim 6, wherein the plurality of selectable initiators and the plurality of content is tailored to a plurality of metadata associated with the mobile device.

10. The method of claim 9, wherein the plurality of metadata includes current location of the mobile device, the date and time that an image, video, or live feed was received from the mobile device, and the frequency of a selectable initiator associated with a specific logo being interacted with on the mobile device.

11. A non-transitory, computer-readable storage media having computer-executable instructions embodied thereon that, when executed by one or more processors of a computing system employing an asset registry platform for a smart logo platform, cause the computing system to:
receive an image, video, or live feed from a camera of a mobile device;
process the image, video, or live feed through a trained logo identification model to determine whether an identified logo is in the image, video, or live feed;
identify a plurality of IDs associated with the identified logos in the image, video or live feed;
cross-reference any identified IDs with a database, wherein the database comprises a plurality of IDs, a plurality of selectable initiators, and a plurality of content wherein each selectable initiator and content is associated with a specific ID;
display the selectable initiator associated with any identified IDs to the mobile device; and
display the content associated with any identified IDs to the mobile device when the selectable initiator is interacted with.

12. The media of claim 11, where the selectable initiator associated with the identified logo is a deeplink that opens a messaging app on the mobile device when selected by a user.

13. The media of claim 12, wherein the messaging app is prepopulated with a message that includes the content associated with the identified logo.

14. The media of claim 11, wherein the plurality of selectable initiators and the plurality of content is tailored to a plurality of metadata associated with the mobile device.

15. The media of claim 14, wherein the plurality of metadata includes current location of the mobile device, the date and time that an image, video, or live feed was received from the mobile device, and the frequency of a selectable initiator associated with a specific logo being interacted with on the mobile device.
